(19) United States
(12) Patent Application Publication
(10) Pub. No.: US 2013/0338334 A1
(43) Pub. Date: Dec. 19, 2013

(54) SULFONATED AROMATIC POLYAMIDES

(71) Applicant: E I DU PONT DE NEMOURS AND COMPANY, Wilmington, DE (US)

(72) Inventors: MICHAEL W. COBB, Wilmington, DE (US); SHARLENE RENEE WILLIAMS, Wilmington, DE (US)

(21) Appl. No.: 13/915,696

(22) Filed: Jun. 12, 2013

Related U.S. Application Data
(60) Provisional application No. 61/660,120, filed on Jun. 15, 2012.

(51) Int. Cl. C08G 69/42

(52) U.S. Cl. CPC C08G 69/42
USPC 528/341

(57) ABSTRACT

Described are sulfonated polyoxadiazole polymers with a high degree of sulfonation and having improved properties such as increased flame retardancy and dyeability. The polymers are useful in articles such as films, fibrids, fibers for floc, and fibers for textile uses, and other articles made from engineering plastics.

This application claims the benefit of priority of U.S. Provisional Application No. 61/660120 filed on Jun. 15, 2012, the entirety of which is herein incorporated by reference.

### FIELD OF THE INVENTION

The invention is directed to sulfonated aromatic polyamides and methods of making said polymers. These polymers are useful as fibers are other articles with increased flame retardancy and dyeability.

### BACKGROUND

Workers that can be exposed to flames, high temperatures, and/or electrical arcs and the like, need protective clothing and articles made from thermally resistant fabrics. Any increase in the effectiveness of these protective articles, or any increase in the comfort, durability, and dyeability of these articles while maintaining protection performance, is welcomed.

Polyamide polymers have unique properties and are useful in many fields, for example high performance fibers, such as flame retardant fibers. One method to improve flammability is to prepare sulfonated polymers. These methods have included the use of sulfonated monomers and post-sulfonation.

There is a need for polymers such as polyamides with a high degree of sulfonation, leading to improved properties such as increased flame retardancy and dyeability.

### SUMMARY

Disclosed is a polymer comprising repeat units of Formula (I):

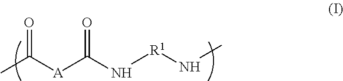

wherein A is a radical of Formula (II), (IIa) or (IIb):

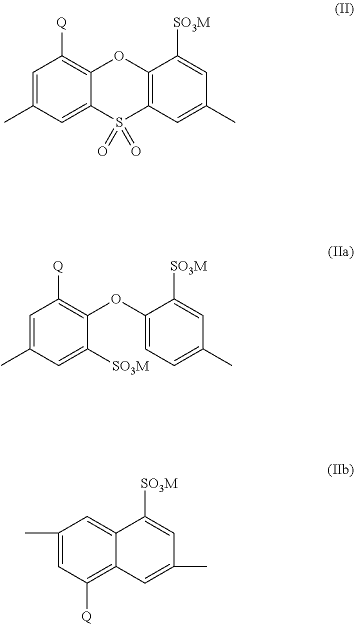

wherein R₁ is a 2 to 12 carbon alkyl or aromatic group, straight chain, branched or cyclic; Q is H or SO₃M; and M is one or more cations.

Also disclosed is a shaped article such as a fiber made from the polymer.

### DETAILED DESCRIPTION

Disclosed is a polymer comprising repeat units of Formula (I):

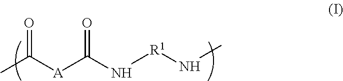

wherein A is a radical of Formula (II), (IIa) or (IIb):

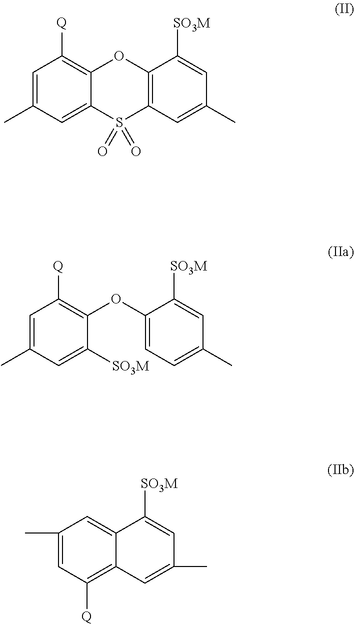

wherein R¹ is a 2 to 12 carbon alkyl or aromatic group, straight chain, branched or cyclic; Q is H or SO₃M; and M is one or more cation.

Typically R¹ is a branched or unbranched alkyl group containing 2 to 12 carbons, or 4-10 carbons, or 6 carbons. Typically R¹ is meta-, ortho-, or para-phenylene, more typically meta-phenylene. R¹ can also be a mixture of meta- and para-functional groups.

In one embodiment A is a radical of Formula (II), or Formula (IIa), or Formula (IIb), or Formula (II) and Formula (IIa).

In one embodiment, M is H, Li, Na, K or NH₄, or mixture thereof, typically H or Na. M can be converted to another M at any time, including before or after the polymer is converted to a shaped article. When M is H, the polymer can be neutralized by contact with a salt, such as but not limited to sodium bicarbonate, sodium hydroxide, cesium hydroxide, lithium hydroxide, potassium hydroxide, or potassium carbonate.

Typically the polymer has a polydispersity of about 2.4 to about 3.3 and a weight average molecular weight of about 10,000 to about 100,000; more typically about 12,000 to about 80,000.

In one embodiment the polymer additionally comprises repeating units of Formula (Ia)

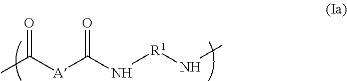

wherein A′ is a radical of Formula (III) or (IIIa).

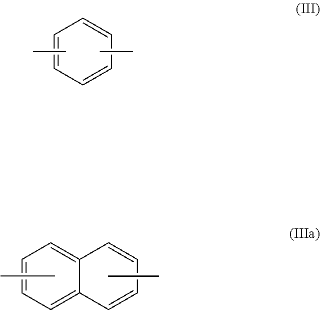

In Formula (III) the substituents can be para, meta, and/or ortho, but is typically meta and/or para; more typically only para. In Formula (IIIa) the substituents can be located in any position on each ring; one on each ring. Typically they are located at the 2 and 6 position.

The polymer can comprise repeating units wherein wherein A is a radical of Formula (III) only, Formula (IIIa) only, or can comprise a mixture of repeating units wherein A is a radical of Formula (III) and Formula (IIIa).

In this embodiment the polymer can have a weight average molecular weight of about 10,000 to about 80,000 and a polydispersity of about 2.4 to about 3.3. The polymer can comprise about 10 to about 99, or about 20 to about 99, or about 30 to about 95, or about 50 to about 90 mole percent of repeat units of Formula (I), and about 1 to about 90, or about 1 to about 80, or about 5 to about 70, or about 10 to about 50 mole percent of repeat units of Formula (Ia).

The polymers described herein can be prepared by methods known in the art, particularly those known to prepare polyamide condensation polymers. Suitable methods are described in Kirk-Othmer Encyclopedia of Chemical Technology, Polyamides, Joseph N. Weber, 2001, John Wiley & Sons, Inc., and (DOI: 10.1002/0471238961.0705140523050205.a01.pub2) and Synthetic Methods in Step-Growth Polymers, M. E. Rogers et al, 2003, John Wiley & Sons, Inc., (DOI: 10.1002/0471220523.ch3).

Polyamides can be synthesized using a variety of polymerization techniques. Two suitable polymerization techniques are (1) reacting a diacid and a diamine and (2) reacting a diacid chloride with a diamine. Typically, aromatic polyamides (aramids) are polymerized in solution at elevated temperatures the presence of polar aprotic solvents, such as dimethylacetamide (DMAC), 1-methyl-2-pyrrolodinone (NMP), or hexamethylphosphoramide (HMPA). They can also be prepared using a tertiary base and salts, such as lithium chloride or calcium chloride. (Principles of Polymerization, George Odian, 2004, John Wiley & Sons, Inc., and Journal of Polymer Science: Part A: Polymer Chemistry, Vol. 47, 1740-1755 (2009).

One method is via the reaction of diamine monomers with the sulfonated aromatic diacid monomers of Formula (III), (IIIa) or (IIIb):

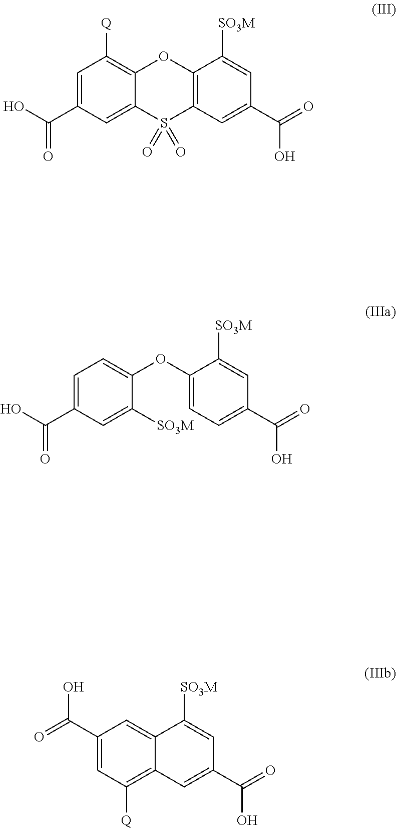

wherein Q is H or SO₃M and M is one or more cations;

M is typically a monovalent cation such as H, Li, Na, K, or NH₄, or mixture thereof, but is typically H or Na.

The polymerization can be performed with the closed ring structure of Formula III, the open ring structure of Formula IIIa, or a mixture of both. Additionally, Q can be either H or SO₃M, or a mixture.

The sulfonated aromatic diacids can be prepared by any method known in the art. One method is via the sulfonation of the corresponding aromatic acids. One synthesis is disclosed in co-pending U.S. Pat. Appl. 61/423616 and U.S. Patent Application No. 61/660101. As therein described, the sulfonated aromatic diacids are made by adding a oleum to an aromatic acid, such as 4,4′-oxybis(benzoic acid) or naphthalene dicarboxylic acid, in the presence of heat. They may be purified by recrystallization or other methods known to those skilled in the art.

The polymers described herein can be formed into a shaped article, such as films, fibrids, fibers for floc, and fibers for textile uses, and other articles made from engineering plastics. Particularly suitable uses are those for which improved flame resistant properties are desired. They can be spun into fibers via solution spinning, using a solution of the polymer in either the polymerization solvent or another solvent for the polymer. Fiber spinning can be accomplished through a multi-hole spinneret by dry spinning, wet spinning, or dry-jet wet spinning (also known as air-gap spinning) to create a multi-filament yarn or tow as is known in the art.

Shaped articles as described herein include extruded or blown shapes or films, molded articles, and the like. Films can be made by any known technique such as casting the dope onto a flat surface, extruding the dope through an extruder to form a film or extruding and blowing the dope film to form an extruded blown film. Typical techniques for dope film extrusion include processes similar to those used for fibers, where the solution passes through a spinneret or die into an air gap and subsequently into a coagulant bath. More details describing the extrusion and orientation of a dope film can be found in Pierini et al. (U.S. Pat. No. 5,367,042); Chenevey, (U.S. Pat. No. 4,898,924); Harvey et al., (U.S. Pat. No. 4,939,235); and Harvey et al., (U.S. Pat. No. 4,963,428). Typically the dope film prepared is preferably no more than about 250 mils (6.35 mm) thick and more preferably it is at most about 100 mils (2.54 mm) thick.

“Fiber” is defined as a relatively flexible, unit of matter having a high ratio of length to width across its cross-sectional area perpendicular to its length. Herein, the term “fiber” is used interchangeably with the term “filament” or “end” or “continuous filament”. The cross section of the filaments described herein can be any shape, such as circular or bean shaped, but is typically generally round, and is typically substantially solid and not hollow. Fiber spun onto a bobbin in a package is referred to as continuous fiber. Fiber can be cut into short lengths called staple fiber. Fiber can be cut into even smaller lengths called floc. Yarns, multifilament yarns or tows comprise a plurality of fibers. Yarn can be intertwined and/or twisted.

“Floc” is defined as fibers having a length of 2 to 25 millimeters, preferably 3 to 7 millimeters and a diameter of 3 to 20 micrometers, preferably 5 to 14 micrometers. If the floc length is less than 3 millimeters, paper strength made from the floc is severely reduced, and if the floc length is more than 25 millimeters, it is difficult to form a uniform paper web by a typical wet-laid method. If the floc diameter is less than 5 micrometers, it can be difficult to commercially produce with adequate uniformity and reproducibility, and if the floc diameter is more than 20 micrometers, it is difficult to form uniform paper of light to medium basis weights. Floc is generally made by cutting continuous spun filaments into specific-length pieces.

The term “fibrids” as used herein, means a very finely-divided polymer product of small, filmy, essentially two-dimensional, particles known having a length and width on the order of 100 to 1000 micrometers and a thickness only on the order of 0.1 to 1 micrometer. Fibrids are made by streaming a polymer solution into a coagulating bath of liquid that is immiscible with the solvent of the solution. The stream of polymer solution is subjected to strenuous shearing forces and turbulence as the polymer is coagulated.

Fibrids and floc prepared from the polymers described herein can be used to form a paper, especially a thermally stable paper or paper that can accept ink or color more readily than other high performance papers. As employed herein the term paper is employed in its normal meaning and it can be prepared using conventional paper-making processes and equipment and processes. The fibrous material, i.e. fibrids and floc can be slurried together to from a mix which is converted to paper such as on a Fourdrinier machine or by hand on a handsheet mold containing a forming screen. Reference may be made to Gross U.S. Pat. No. 3,756,908 and Hesler et al. U.S. Pat. No. 5,026,456 for processes of forming fibers into papers. If desired, once the paper is formed it is calendered between two heated calendering rolls with the high temperature and pressure from the rolls increasing the bond strength of the paper. Calendering also provides the paper with a smooth surface for printing. Several plies with the same or different compositions can be combined together into the final paper structure during forming and/or calendering. In one embodiment, the paper has a weight ratio of fibrids to floc in the paper composition of from 95:5 to 10:90. In one preferred embodiment, the paper has a weight ratio of fibrids to floc in the paper composition of from 60:40 to 10:90.

The paper is useful as printable material for high temperature tags, labels, and security papers. The paper can also be used as a component in materials such as printed wiring boards; or where dielectric properties are useful, such as electrical insulating material for use in motors, transformers and other power equipment. In these applications, the paper can be used by itself or in laminate structures either with or without impregnating resins, as desired. In another embodiment, the paper is used as an electrical insulative wrapping for wires and conductors. The wire or conductor can be totally wrapped, such a spiral overlapping wrapping of the wire or conductor, or can wrap only a part or one or more sides of the conductor as in the case of square conductors. The amount of wrapping is dictated by the application and if desired multiple layers of the paper can be used in the wrapping. In another embodiment, the paper can also be used as a component in structural materials such as core structures or honeycombs. For example, one or more layers of the paper may be used as the primarily material for forming the cells of a honeycomb structure. Alternatively, one or more layers of the paper may be used in the sheets for covering or facing the honeycomb cells or other core materials. Preferably, these papers and/or structures are impregnated with a resin such as a phenolic, epoxy, polyimide or other resin. However, in some instances the paper may be useful without any resin impregnation.

Fibers may be spun from solution using any number of processes, however, dry spinning is preferred for polyamides.

“Dry spinning” means a process for making a filament by extruding a solution into a heated chamber having a gaseous atmosphere to remove the solvent, leaving a solid filament. The solution comprises a fiber-forming polymer in a solvent which is extruded in a continuous stream through one or more spinneret holes to orient the polymer molecules. This is distinct from “wet spinning” or “air-gap spinning” wherein the polymer solution is extruded into a liquid precipitating or coagulating medium to regenerate the polymer filaments. In other words, in dry spinning a gas is the primary solvent extraction medium, and in wet spinning a liquid is the primary solvent extraction medium. In dry spinning, after formation of solid filaments, the filaments can then be treated with a liquid to either cool the filaments or wash the filaments to further extract remaining solvent.

The fibers in the multi-filament yarn, or tow, after spinning can then be treated to neutralize, wash, dry, or heat treat the fibers as needed using conventional technique to make stable and useful fibers. The fibers formed from the polymers described herein are useful in a variety of applications. They are colorless, although impurities can impart discoloration, and are particularly useful as flame retardant fibers.

### EXAMPLES

Unless otherwise stated, the examples were all prepared using the following procedures. Ratios of reagents are given as mole ratios. para-Phenylene diamine (PPD) and meta-phenylene diamine (MPD), were obtained from E. I. du Pont de Nemours and Company, Wilmington, Del. Terephthalic acid (TPA), isophthalic acid (IPA), 4,4′-oxybis(benzoic acid) (OBBA), 1,4-dioxane, thionyl chloride, oxalyl chloride, butylamine, calcium chloride, N-methylpyrrolidone (NMP), triphenylphosphite, sulfuric acid, hexamethylene diamine (HMD), 2,6-naphthalene dicarboxylic acid, and pyridine were obtained from Sigma-Aldrich®. Methanol (MeOH) was obtained from BDH. Acetonitrile was obtained from EMD Chemicals.

### Examples 1-8

### Sulfonylated 4,4′-oxybis(benzoic acid)

A 40 mL vial containing a magnetic stir bar was charged with 4,4′-oxybis(benzoic acid) (6.0 g) and 30% oleum (39.6 g). The mixture was heated in a 130° C. hot block for 3 days. Samples (1 mL) of the resulting clear brown solution were then quenched with water and vortexed to mix. The precipitated solids were filtered and sparingly washed with ice water. The remaining solid was predominately the monosulfonated sulfone product and the aqueous filtrate predominately contained the disulfonated sulfone. ¹H NMR spectrum and LC/MS were performed and indicate that the desired sulfonated and sulfonylated products were formed.

A saturated solution of the monosulfonated sulfone product was prepared in water-d₂ containing a trace of sodium 3-trimethylsilylpropionate-d₄ as a chemical shift referent. The solution was inserted in a NMR probe and heated to 60° C. to ensure dissolution. A series of NMR two dimensional correlation experiments were performed to elucidate the structure of the material. These experiments permitted assignment of the ¹H resonances of the primary product, 4-sulfophenoxathiine-2,8-dicarboxylic acid 10,10-dioxide. The ¹H assignments (in ppm relative to chemical shift referent at 0.00 ppm) are shown in the following below.

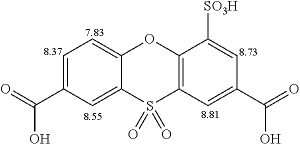 [SMILES: O=C(O)c1ccc2c(c1)S(=O)(=O)c1cc(C(=O)O)cc(S(=O)(=O)O)c1O2]

### General Polyamide Polymerization Procedure

Unless otherwise specified, the following general polymerization procedure was used in each example while varying the ratio of the carboxylic acid monomers as specified in Table 1. The molar ratio of diamine to dicarboxylic acid was always 1:1. In a drybox, a 20 mL vial with a stirbar was charged with the carboxylic acids indicated in the table (1.200 mmol), diamines (1.200 mmol), CaCl₂ (0.208 g), NMP (2 mL), triphenyl phosphite (1.2 mL), and pyridine (0.400 mL). The solids did not appear to dissolve at room temperature. The mixture was placed in a 120° C. hot block. After approximately 15 minutes, the solution was clear yellow with a small amount of solids at the bottom of the vial. After approximately 25 minutes, the reaction was a viscous yellow gel with some solids at the bottom of the vial. The solids were believed to be CaCl₂. The temperature was increased to 140° C. for 1 hour. The viscous yellow solution flowed very slowly at room temperature. MeOH (15 mL) was added to the vial and stirred. A white polymer precipitated. The precipitation was repeated and the material was washed with hot water and MeOH. The solid was then dried in a vacuum oven for 18 hours at 125° C. The isolated polymer were solids and off-white to white in color.

The results are shown in Table 1 below.

TABLE 1

| EX | Diamine | TPA | IPA | S-OBBA | Mn | Mw | Mw/Mn |
|---|---|---|---|---|---|---|---|
| 1⁽¹⁾ | MPD | 0 | 100 | 0 | 14300 | 34500 | 2.41 |
| 2 | MPD | 0 | 80 | 20 | 11400 | 27800 | 2.43 |
| 3 | MPD | 0 | 50 | 50 | 7500 | 19000 | 2.53 |
| 4 | PPD | 0 | 0 | 100 | 10100 | 26000 | 2.59 |
| 5 | MPD | 0 | 90 | 10 | 22000 | 72100 | 3.28 |
| 6⁽¹⁾ | HMD | 100 | 0 | 0 | 5500 | 14000 | 2.55 |
| 7 | HMD | 80 | 0 | 20 | 4000 | 13000 | 3.25 |

⁽¹⁾Comparative example
HMD = Hexamethylene diamine
PPD = paraphenylene diamine
MPD = metaphenylene diamine
TPA = terephthalic acid
IPA = isophthalic acid
S-OBBA = sulfonated OBBA

### Example 8

### Acid Chloride Synthesis

In a drybox, two 20 mL vials with stirbars were charged with sulfonated OBBA (0.5005 g, 1.250 mmol) and dioxane. This was allowed to stir at 60° C. for 15 min. The solid did not dissolve. The vial was removed from the heat and allowed to cool to room temperature. Oxalyl chloride (0.2433 mL, 2.8754 mmol) was added to one vial and thionyl chloride (0.2102 mL, 2.8818 mmol) was added to another vial. The vials were then allowed to heat to 60° C. for several hours. Samples were taken for LC-MS analysis by first reacting the acid chloride with butylamine and analyzing that product. This was done because the diacid chloride would hydrolyze in water to the starting material.

### Example 9

### Sulfonation of 2,6-naphthalene dicarboxylic acid

2,6-Naphthalene dicarboxylic acid (0.5053 g) was added to 27.9 g of 18.7% oleum. The material was heated to 130° C. and reacted with stirring by magnetic bar for 30 minutes. The reaction was removed from heat and allowed to cool to room temperature. ¹H NMR spectrum and LC/MS were performed and indicate that the desired sulfonated products were formed. A saturated solution of the monosulfonated sulfone product was prepared in water-d₂ containing a trace of sodium 3-trimethylsilylpropionate-d₄ as a chemical shift referent. The solution was inserted in a NMR probe. Literature comparison permitted assignment of the ¹H resonances of the primary disulfonated product. The ¹H assignments (in ppm relative to chemical shift referent at 0.00 ppm) are shown in the following below.

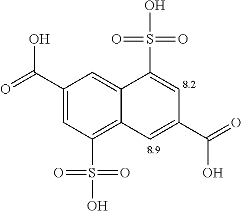 [SMILES: O=C(O)c1cc(S(=O)(=O)O)c2cc(C(=O)O)cc(S(=O)(=O)O)c2c1]

What is claimed is:

1. A polymer comprising repeat units of Formula (I): 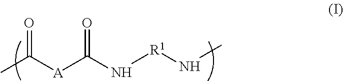
wherein A is a radical of Formula (II), (IIa) or (IIb): 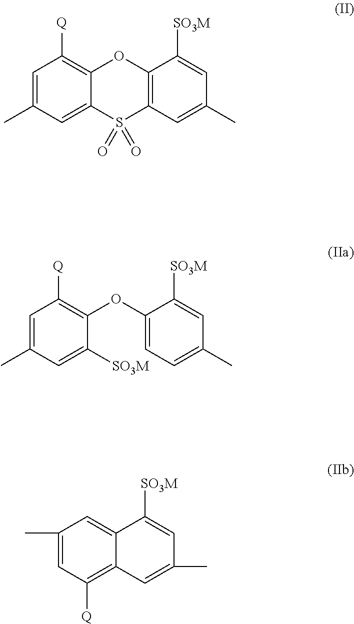
wherein R¹ is a 2 to 12 carbon alkyl or aromatic group, straight chain, branched or cyclic; Q is H or SO₃M; and M is one or more cations.

2. The polymer of claim 1 wherein M is H, Li, Na, K or NH₄, or mixture thereof.

3. The polymer of claim 1 wherein R¹ is a branched or unbranched alkyl group containing 2 to 12 carbons.

4. The polymer of claim 1 wherein R¹ is meta-, ortho-, or para-phenylene.

5. The polymer of claim 1 wherein Q is H or Na.

6. The polymer of claim 1 wherein the polymer has a weight average molecular weight of about 10,000 to about 100,000 and a polydispersity of about 2.4 to about 3.3.

7. The polymer of claim 1 additionally comprising repeating units of Formula (Ia) 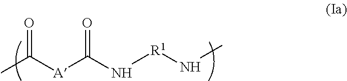
wherein A′ is a radical of Formula (III) or (IIIa).

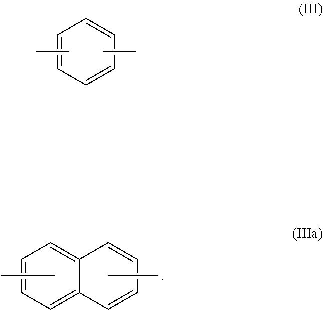

8. The polymer of claim 7 comprising about 1 to about 90 mole percent of repeat units of Formula (I) and about 10 to about 90 mole percent of repeat units of Formula (Ia).

9. The polymer of claim 3 wherein the polymer has a weight average molecular weight of about 10,000 to about 80,000 and a polydispersity of about 2.4 to about 3.3.

10. The polymer of claim 7 wherein A′ is a radical of Formula (III).

11. A shaped article made from the polymer of claim 1.

12. The shaped article of claim 11 that is a fiber.
